(19) United States
(12) Patent Application Publication
(10) Pub. No.: US 2019/0061774 A1
(43) Pub. Date: Feb. 28, 2019

(54) PLAN FOR GUIDING A MOTOR VEHICLE DRIVERLESSLY ON AN INCLINED RAMP OF A PARKING LOT

(71) Applicant: Robert Bosch GmbH, Stuttgart (DE)

(72) Inventor: Stefan Nordbruch, Kornwestheim (DE)

(21) Appl. No.: 16/114,382

(22) Filed: Aug. 28, 2018

(30) Foreign Application Priority Data
Aug. 31, 2017 (DE) 102017215208.7

(51) Int. Cl. B60W 50/02; G08G 1/16; G08G 1/14; B60W 30/06

(52) U.S. Cl. CPC B60W 50/02; B60W 30/06; G08G 1/146; G08G 1/168

(57) ABSTRACT

A method for guiding a motor vehicle driverlessly on an inclined ramp of a parking lot using one or more motor vehicle components includes conducting a test for the correct functioning of the utilized motor vehicle components proactively prior to and during a driverlessly guided trip of the motor vehicle on the ramp; and, in response to detection of a fault in one of the motor vehicle components and/or detection of diminished functionality in one of the motor vehicle components relative to a reference functionality value, controlling one or more actions to reduce a risk of a possible collision of the motor vehicle with an object due to the faulty motor vehicle component or due to the reduced functionality.

### CROSS-REFERENCE TO RELATED APPLICATIONS

The present application claims priority under 35 U.S.C. § 119 to DE 10 2017 215 208.7, filed in the Federal Republic of Germany on Aug. 31, 2017, the content of which is hereby incorporated by reference herein in its entirety.

### FIELD OF THE INVENTION

The present invention relates to a device and a method for guiding a motor vehicle driverlessly on an inclined ramp of a parking lot. The present invention further relates to a motor vehicle, as well as to a computer program.

### BACKGROUND

The published unexamined patent application DE 10 2012 222 562 A1 shows a system for managed parking areas for transporting a vehicle from a starting position to a target position.

In the case of fully automatic (autonomous), so-called valet parking, a vehicle is parked by its driver at a handover location, for example, in front of a parking garage, and from there, the vehicle drives itself into a parking position/parking bay and back again to the handover location.

As a rule, parking garages have several floors, which are interconnected by ramps. If, for example, a brake system of a vehicle fails when it is traveling, in particular, on the ramp, then there is a risk of the vehicle going down the ramp in an uncontrolled manner and possibly colliding with objects, such as people, walls, pillars, or other vehicles.

### SUMMARY

The object of the present invention is to provide an efficient plan for efficiently guiding a motor vehicle driverlessly on an inclined ramp of a parking lot, which reduces a risk of collision of the motor vehicle with objects.

According to one aspect, a method is provided for guiding a motor vehicle driverlessly on an inclined ramp of a parking lot using one or more motor vehicle components; a test for the correct functioning of the utilized motor vehicle components being conducted proactively prior to and during a driverlessly guided trip of the motor vehicle on the ramp; in response to detection of a fault in one of the motor vehicle components and/or detection of diminished functionality in one of the motor vehicle components relative to a reference functionality value, one or more actions being controlled, in order to reduce a risk of a possible collision of the motor vehicle with an object due to the faulty motor vehicle component or due to the reduced functionality.

According to a further aspect, a device is provided for driverlessly guiding a motor vehicle on an inclined ramp of a parking lot using one or more motor vehicle components, the device including a control device for proactively conducting a test for the correct functioning of the utilized motor vehicle components prior to and during a driverlessly guided trip of the motor vehicle on the ramp; and a control device for controlling one or more actions in response to detection of a fault in one of the motor vehicle components and/or detection of diminished functionality in one of the motor vehicle components relative to a reference functionality value, in order to reduce a risk of a possible collision of the motor vehicle with an object, due to the faulty motor vehicle component or due to the reduced functionality.

According to a further aspect, a motor vehicle is provided, which includes the device for guiding a motor vehicle driverlessly on an inclined ramp of a parking lot.

According to a further aspect, a computer program is provided, which includes program code for implementing the method for guiding a motor vehicle driverlessly on an inclined ramp of a parking lot, when the computer program is executed on a computer, for example, on the device for guiding a motor vehicle driverlessly on an inclined ramp of a parking lot.

The present invention is based on the finding, that the above-mentioned object can be achieved by not waiting until a fault or reduced functionality is signaled by one of the utilized motor vehicle components, before an action is initiated or controlled. Instead, the present invention provides that a test for correct functioning of the utilized motor vehicle components be conducted proactively.

Thus, this means that even if none of the motor vehicle components signals a fault, the motor vehicle components used are still checked for faults or for reduced functionality.

Therefore, this produces a technical advantage that any faults or instances of reduced functionality possibly present can be detected earlier in comparison with the case in which a fault or an instance of reduced functionality is signaled by the affected motor vehicle component itself. For example, this produces a technical advantage that the one or more actions can be controlled or started earlier, which means that a risk of a possible collision of the motor vehicle with an object, due to the faulty motor vehicle component or due to the reduced functionality, can be decreased in an efficient manner. Consequently, this produces the technical advantage that the collision risk can be reduced even further.

Thus, this produces a technical advantage that an efficient plan is provided for driverlessly guiding a motor vehicle on an inclined ramp of a parking lot, in an efficient manner.

Therefore, for example, if a fault or reduced functionality occurs in one of the utilized motor vehicle components, for example, while the motor vehicle is traveling on the ramp, this could cause the motor vehicle to roll down or drive down the ramp uncontrollably. This could result in a collision of the motor vehicle with an object in the area of the motor vehicle or in the area of the ramp.

As described above, the present invention provides that due to the proactive test for correct functioning, such faults or functionality be detected early, in particular, in a timely manner, in order to lessen or, in some instances, even completely eliminate the potentially negative effects, which result from the fault or reduced functionality.

In an example embodiment, a fault or an instance of decreased functionality is detected if a probability that a fault or instance of reduced functionality could occur has been ascertained, which is greater than or equal to a predetermined threshold probability value.

Thus, this means that a probability that a fault or instance of reduced functionality could occur is ascertained, the ascertained probability being compared to the predetermined threshold probability value. If the ascertained probability is greater than or greater than or equal to the predetermined probability value, it is determined or defined or stipulated that a fault or instance of reduced functionality is present.

Thus, this example embodiment takes into account that the one or more actions can also be controlled, if, namely, no fault or reduced functionality has occurred or is present, but there is still a certain probability, that a fault or instance of decreased functionality could occur. This produces, for example, a technical advantage that collisions can be prevented more efficiently.

An inclined ramp denotes, in particular, a ramp, which interconnects two planes, which are set apart from each other, and thus, in particular, are situated at different heights with respect to a reference point. The planes are, for example, floors of the parking lot. The reference point is, for example, the ground.

Thus, the inclined ramp forms an inclined plane and can be referred to as such. Thus, this means that according to an example embodiment, the ramp connects a first floor of the parking lot to a second floor of the parking lot.

Driverless guidance of the motor vehicle means that the motor vehicle is not driven or controlled by a human driver, who is situated inside of the motor vehicle. To be sure, a person can be situated in the motor vehicle, but the person, in particular, does not control the motor vehicle during the driverlessly guided trip.

For example, there might not be any person inside of the motor vehicle during the driverlessly guided trip. Thus, this means, for example, that the motor vehicle is free of a person, while it is guided in a driverless manner.

Driverless or operatorless guidance of the motor vehicle can mean that the motor vehicle is remote-controlled, or that the motor vehicle travels autonomously, that is, independently. For example, it is provided that the motor vehicle cover a portion of the ramp autonomously and a further portion of the ramp remote-controlled.

According to an example embodiment, it is provided that the one or more actions be planned before the motor vehicle travels on the ramp and/or during and/or after the proactive test for the correct functioning of the motor vehicle. This produces, for example, a technical advantage that, if needed, the actions can be carried out immediately. In this manner, a risk of collision can advantageously be reduced even more efficiently.

In an example embodiment, one predetermined action or a plurality of predetermined actions are planned for a predetermined fault or a predetermined instance of reduced functionality. Thus, this means that, for example, action B is planned for fault A. This brings about, in particular, a technical advantage that in response to detection of the fault or reduced functionality, the actions planned in this manner can be initiated immediately.

In an example embodiment, one or more actions are planned in response to detection of a fault or reduced functionality, which is not predetermined, that is, was not considered beforehand in the context of the action planning.

Thus, this means, in particular, that in response to faults or instances of reduced functionality, which were not considered in the context of prior action planning, one or more corresponding actions are planned spontaneously.

According to a further example embodiment, it is provided that the one or more motor vehicle components include an electrical system of the motor vehicle; the test for correct functioning including the measuring of at least one electrical variable of the vehicle electrical system; a fault being present if the at least one measured variable lies outside of a predetermined electrical variable range. This produces, for example, a technical advantage that faults in the vehicle electrical system can be detected efficiently.

The at least one electrical variable of the vehicle electrical system includes, for example, an electrical current or an electrical voltage. Thus, for example, only a slight decrease in an electrical voltage or an electrical current in the vehicle electrical system would not necessarily result in the vehicle electrical system signaling, of its own accord, a fault or an instance of decreased functionality. Nevertheless, such a slight decrease can be an indication or a sign that the vehicle electrical system will fail soon, or that the vehicle electrical system can only provide diminished or reduced functionality, for example, can only supply a limited number of motor vehicle components with electrical energy.

Since, according to this example embodiment, it is determined that a fault is present if at least one measured variable lies outside of a predetermined electrical variable range, such cases can be reacted to in an efficient manner.

A slight decrease in the electrical variable refers, for example, to a decrease of at least 1%, e.g., at least 3%, e.g., at least 5%, of a predetermined setpoint value of the electrical variable.

According to an example embodiment, it is provided that the one or more motor vehicle components include a brake system of the motor vehicle; the test for correct functioning including a check if a predetermined brake pressure in the form of a reference functionality value can be generated by the brake system; and an instance of reduced functionality being present if the brake system cannot generate the predetermined brake pressure.

This produces, for example, a technical advantage that any existing faults in the brake system or any instances of reduced or diminished functionality present in the brake system can be detected timely and efficiently.

According to an example embodiment, the brake system includes a parking brake (also called a hand brake) and/or a foot brake. Consequently, the corresponding (predetermined) brake pressure is, in particular, specific to the parking brake or the foot brake, that is, in particular, assigned to the parking brake or the foot brake.

According to an example embodiment, it is provided that the one or more motor vehicle components include a communications bus of the motor vehicle; the test for correct functioning including a check if a main control unit of the motor vehicle can communicate with the utilized motor vehicle components, and/or if the utilized motor vehicle components can communicate with each other via the communications bus; a fault being present, if the main control unit is unable to communicate with all of the utilized motor vehicle components, or if the utilized motor vehicle components are unable to communicate among each other.

This produces, for example, a technical advantage that faults in the communication or instances of reduced functionality in the communication between the main control unit and the utilized motor vehicle components can be detected efficiently.

In the case of a driverlessly guided trip of a motor vehicle, it is normally important that the main control unit be able to communicate reliably with the utilized motor vehicle components. For example, it is important that the main control unit be able to communicate reliably with a brake system, a steering system, and/or a drive system of the motor vehicle for the driverlessly guided trip.

A breakdown in these communication links can possibly result in the motor vehicle rolling or driving down the ramp in an uncontrolled manner.

However, according to this example embodiment, such cases can advantageously be responded to in an efficient and timely manner.

According to another example embodiment, it is provided that the communications bus be a CAN bus or an Ethernet network or a FlexRay bus.

According to another example embodiment, it is provided that the communications bus include a CAN bus and/or an Ethernet network and/or a FlexRay bus.

The main control unit is, for example, a so-called head unit.

According to an example embodiment, the one or more motor vehicle components include a communications bus of the motor vehicle; the test for correct functioning including a check if a control unit, for example, a main control unit, of the motor vehicle can communicate with the utilized motor vehicle components via the communications bus; a fault being present, if the control unit, for example, the main control unit, is unable to communicate with all of the utilized motor vehicle components.

The control unit is configured, for example, to guide the motor vehicle driverlessly in a parking lot and is, for example, different from the main control unit.

The control unit, which is configured, for example, to guide the motor vehicle driverlessly in a parking lot, is configured, for example, to automatically park the motor vehicle and/or move it out of a parking space.

The control unit, which is configured, for example, to guide the motor vehicle driverlessly in a parking lot and, for example, to automatically park the motor vehicle and/or move it out of a parking space, is encompassed, for example, by a parking assistant of the motor vehicle.

The control unit, which is configured, for example, to guide the motor vehicle driverlessly in a parking lot and, for example, to automatically park the motor vehicle and/or move it out of a parking space, can be referred to, for example, as an AVP control unit. AVP stands for “automated valet parking” and can be regarded as an automatic parking operation.

If the singular is used for “control unit,” it should always be understood to also include an instance of the plural, and vice versa.

In another example embodiment, it is provided that in response to detection of a fault in one of the motor vehicle components and/or of reduced functionality just prior to traveling on the ramp, the one or more actions include driverless guidance of the motor vehicle in such a manner, that the motor vehicle initially does not travel on the ramp at all.

This produces, for example, a technical advantage that an uncontrolled trip of the motor vehicle on the ramp, that is, for example, unchecked downward rolling or downward traveling of the motor vehicle, can be prevented in an efficient manner.

According to another example embodiment, the one or more actions are each selected as an element from the following group of actions: braking the motor vehicle; stopping the motor vehicle; driverlessly guiding the motor vehicle in such a manner that the motor vehicle collides with an infrastructure element of the parking lot; adjusting the steering of the motor vehicle in such a manner that the motor vehicle is brought onto a collision course with an infrastructure element of the parking lot; sending a message over a wireless communications network to one or more users of the parking lot and/or to a parking lot administrative system of the parking lot, that there is a problem; and outputting one or more warning signals.

This produces, for example, a technical advantage that the collision risk can be reduced efficiently.

A warning signal can be an optical or an acoustic or a haptic warning signal.

Braking of the motor vehicle includes reducing a motor vehicle speed. In particular, in an example embodiment, braking of the motor vehicle includes braking the motor vehicle to a dead stop of the motor vehicle, that is, stopping the motor vehicle.

Guiding the motor vehicle driverlessly in such a manner that the motor vehicle collides with an infrastructure element of the parking lot, has, in particular, a technical advantage that a motor vehicle speed of the motor vehicle can be efficiently reduced, for example, to 0 m/s.

Consequently, e.g., a controlled collision of the motor vehicle with the infrastructure element of the parking lot takes place. Therefore, this advantageously prevents the motor vehicle from colliding with an object other than the infrastructure element of the parking lot.

Along the lines of the description, an object can be, for example, one of the following objects: another motor vehicle, a pedestrian, an animal, and a road user.

Adjusting the steering of the motor vehicle in such a manner that the motor vehicle is brought onto a collision course with an infrastructure element of the parking lot, has, in particular, a technical advantage that in the case of an uncontrolled trip, or rather, uncontrolled downward rolling of the motor vehicle, due to the fault or the decreased functionality, the motor vehicle will then collide with the infrastructure element of the parking lot, which means that in this connection, a motor vehicle speed decreases in an efficient manner, for example, to 0 m/s.

Therefore, an object of this example embodiment is that the motor vehicle collides with the infrastructure element in place of with an object in the area of the motor vehicle or the ramp.

Along the lines of the description, an infrastructure element can be, for example, one of the following infrastructure elements: wall, column, boundary post, curb, archway, and railing.

A wireless communications network includes, for example, a WLAN communications network and/or a cellular network.

The plurality of road users includes, for example, additional motor vehicles or pedestrians.

The parking lot administrative system of the parking lot is configured, for example, to control or monitor operation of the parking lot.

In an example embodiment, the device for guiding a motor vehicle in a driverless manner is equipped or configured to execute or implement the method for guiding a motor vehicle in a driverless manner.

According to an example embodiment, it is provided that the method for guiding a motor vehicle in a driverless manner be executed or implemented, using the device for guiding a motor vehicle in a driverless manner.

Therefore, this means, for example, that technical functionality of the device for driverlessly guiding a motor vehicle is derived directly from technical functionality of the method for driverlessly guiding a motor vehicle, and vice versa.

In particular, this therefore means that device features are derived from corresponding method features, and vice versa.

In an example embodiment, the motor vehicle is equipped or configured to execute or implement the method for guiding a motor vehicle in a driverless manner.

According to an example embodiment, the method for driverlessly guiding a motor vehicle is implemented by the motor vehicle.

For example, the one or more motor vehicle components are each an element from the following group of motor vehicle components: steering system, brake system, drive system, clutch system, vehicle electrical system, control unit, communications bus, and main control unit.

According to an example embodiment, the main control unit is configured to guide the motor vehicle driverlessly, in particular, to guide it driverlessly on the ramp.

According to an example embodiment, driverless guidance of the motor vehicle includes controlling lateral and/or longitudinal guidance of the motor vehicle.

According to an example embodiment, it is provided that the motor vehicle includes the one or more motor vehicle components.

In the case of a brake system, the reference functionality value corresponds, for example, to a predetermined brake pressure, which must at least be generated by the brake system.

In the case of a drive system, the reference functionality value corresponds, for example, to a predetermined minimum driving power.

The reference functionality value corresponds, for example, to complete, that is, full functionality. Thus, this means that the reduced functionality is determined, for example, relative to a maximum functionality that can be provided.

In the following, the present invention is explained in greater detail in light of preferred exemplary embodiments with reference to figures.

### BRIEF DESCRIPTION OF THE DRAWINGS

FIG. 1 is a flowchart that illustrates a method for guiding a motor vehicle driverlessly on an inclined ramp of a parking lot, according to an example embodiment of the present invention.

FIG. 2 illustrates a device for guiding a motor vehicle driverlessly on an inclined ramp of a parking lot, according to an example embodiment of the present invention.

FIG. 3 illustrates a motor vehicle, according to an example embodiment of the present invention.

FIG. 4 illustrates a parking lot, according to an example embodiment of the present invention.

### DETAILED DESCRIPTION

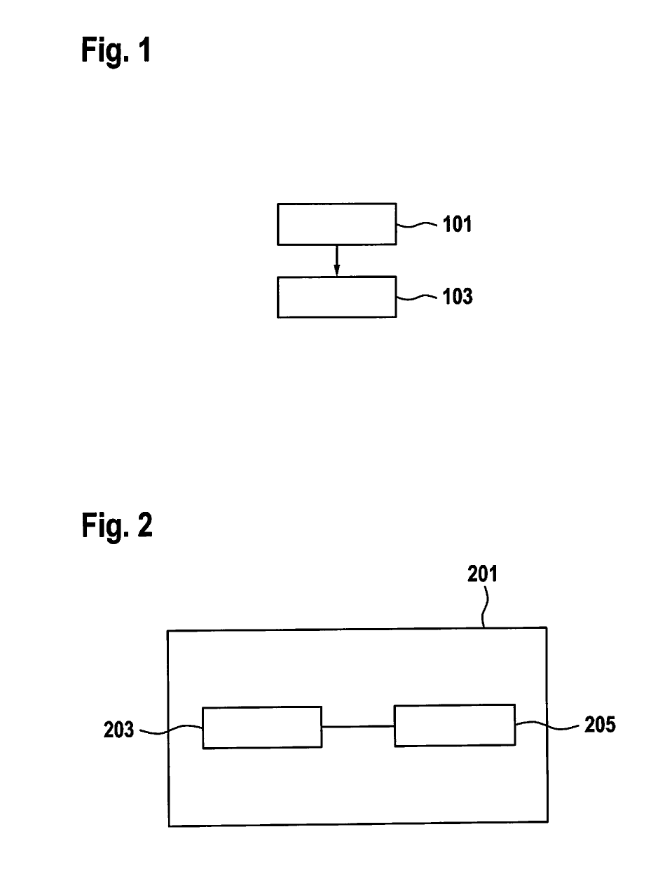

FIG. 1 is a flowchart illustrating a method for guiding a motor vehicle driverlessly on an inclined ramp of a parking lot, using one or more motor vehicle components. According to a step 101, a test for the correct functioning of the utilized motor vehicle components is conducted proactively prior to and during a driverlessly guided trip of the motor vehicle on the ramp.

In response to detection of a fault in one of the motor vehicle components and/or of reduced functionality in one of the motor vehicle components relative to a reference functionality value, one or more actions are controlled according to a step 103, in order to reduce a risk of a possible collision of the motor vehicle with an object, due to the faulty motor vehicle component or due to the reduced functionality.

Therefore, this produces, in particular, a technical advantage that potentially negative effects in the event of a failure of utilized motor vehicle components during a trip of the motor vehicle on a ramp, can be efficiently lessened or, in some instances, even prevented completely.

Therefore, this means, for example, that the one or more actions are preferably controlled or executed not only prior to traveling on the ramp, but also during the trip on the ramp (ramp trip). For example, this advantageously allows the one or more actions to be carried out in a situationally adapted manner.

The plan of the present invention is based on a proactive test for correct functioning, that is, a proactive check test or monitoring of the important or necessary motor vehicle components, which are needed for the driverlessly guided trip of the motor vehicle on the ramp.

In particular, it is provided that the utilized motor vehicle components be tested for complete, that is, for 100% functionality.

Thus, according to an example embodiment, all of the motor vehicle components used for the ramp trip (driverlessly guided trip of the motor vehicle on the ramp) must function at 100%. Otherwise, according to an example embodiment, the one or more actions are controlled.

This is in contrast with the procedure known up to now, where it is waited until one of the motor vehicle components signals a fault, in which case, this fault is responded to only then.

This is in further contrast with known methods, in which nothing is done; therefore, this means that to date, in response to a fault in one of the motor vehicle components, the vehicle would then normally roll down the ramp uncontrolled or unbraked.

Thus, according to an example embodiment, if 100% functionality is not available or there is the possibility that a reduction could come, for example, since an electrical voltage or electrical current of the vehicle electrical system has changed minimally, then an example embodiment provides for the one or more actions to be controlled, that is, in particular, to be initiated and additionally monitored or carried out.

The actions include, for example, one or more of the following actions: braking the motor vehicle, for example, using a brake system of the motor vehicle; driverlessly guiding the motor vehicle against an obstacle, that is, braking the motor vehicle, using an obstacle, such as an infrastructure element of the parking lot; adjusting the steering of the motor vehicle in such a manner, that at a later time, it runs against an obstacle, for example, an infrastructure element of the parking lot, even without further influencing control or monitoring; and communicating to other road users or to a parking lot administrative system, also called a parking lot management system, that a probable or possible problem exists. The parking lot administrative system can advantageously react to the situation in an efficient manner and, for example, warn other road users of the parking lot, as well, or send service personnel to the ramp.

According to an example embodiment, concurrently or prior to the proactive check of the utilized motor vehicle components, in each instance, all of the possible actions are already preplanned, in particular, specific to the existing surroundings, or more precisely, the ramp at hand, and in particular, specific to the fault or the reduced functionality, which means that these can be initiated immediately in an advantageous manner in response to detected (possible) problems.

FIG. 2 shows a device 201 for guiding a motor vehicle driverlessly on an inclined ramp of a parking lot, using one or more motor vehicle components. Device 201 includes a checking device 203 for proactively conducting a test for correct functioning of the utilized motor vehicle components prior to and during a driverlessly guided trip of the motor vehicle on the ramp; and a control device 205 for controlling one or more actions in response to detection of a fault in one of the motor vehicle components and/or detection of diminished functionality in one of the motor vehicle components relative to a reference functionality value, in order to reduce a risk of a possible collision of the motor vehicle with an object, due to the faulty motor vehicle component or due to the decreased functionality.

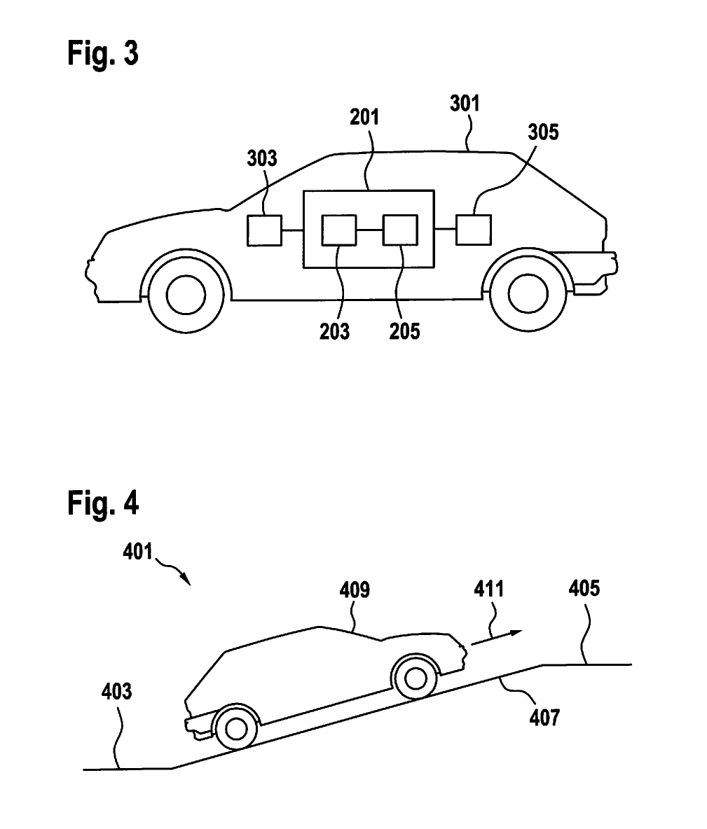

FIG. 3 shows a motor vehicle 301 that includes a plurality of motor vehicle components 303, 305. Motor vehicle 301 includes the device 201 as shown in FIG. 2. This advantageously produces a technical advantage that device 201 can check motor vehicle components 303, 305 for faults or for reduced functionality.

FIG. 4 shows a parking lot 401. Parking lot 401 includes a first floor 403 and a second floor 405, which is situated above first floor 403. An inclined ramp 407, also called an inclined plane, connects the two floors 403, 405. A motor vehicle 409 travels from first floor 403 to second floor 405 via ramp 407. A direction of travel of motor vehicle 409 is denoted by an arrow having the reference numeral 411. Direction of travel 411 is predetermined, in particular, by ramp 407, which sets, in this respect, a path of travel for motor vehicle 409.

Motor vehicle 409 can be, for example, the motor vehicle 301 as shown in FIG. 3. According to an example embodiment, motor vehicle 409 includes a device for guiding a motor vehicle driverlessly; the device not being shown for the sake of clarity.

According to FIG. 4, motor vehicle 409 travels up ramp 407. In an example embodiment not shown, it is provided that motor vehicle 409 travel down ramp 407.

In general, a ramp trip refers to a trip of the motor vehicle up or down the ramp.

The motor vehicle components, which are used for the driverlessly guided trip of the motor vehicle and are also not shown in FIG. 4 for the sake of clarity, designate, in general, motor vehicle components that can be absolutely necessary for the driverlessly guided trip of the motor vehicle. Thus, these are subjected to, in particular, a proactive test for correct functioning. In particular, a proactive test for correct functioning takes place regularly.

Thus, along the lines of the description, proactive means, in particular, that the test for correct functioning is conducted without a specific cause. Therefore, the test for correct functioning is conducted without a specific reason.

Consequently, an efficient plan is provided for efficiently reducing the potentially negative effects in response to a failure of motor vehicle components during a driverlessly guided ramp trip of the motor vehicle.

What is claimed is:

1. A method comprising:
prior to and during a driverlessly guided trip of a motor vehicle on an inclined ramp of a parking lot, conducting a test to determine whether one or more motor vehicle components used for the driverless guidance are functioning properly; and
in response to detection, as a result of the conducted test, of a fault in, or a diminished functionality, relative to a reference functionality value, of one of the motor vehicle components, executing a control of one or more actions to reduce a risk of a possible collision of the motor vehicle with an object due to the faulty or functionally diminished motor vehicle component.

2. The method of claim 1, wherein the one or more actions is planned before the motor vehicle travels on the ramp or during or after the conducting of the test.

3. The method of claim 1, wherein:
the one or more motor vehicle components includes a vehicle electrical system of the motor vehicle;
the test includes measuring at least one electrical variable of the vehicle electrical system;
the control is executed in response to the detection of the fault; and
the fault is detected based on the measured at least one electrical variable being outside of a predetermined electrical variable range.

4. The method of claim 1, wherein:
the one or more motor vehicle components includes a brake system of the motor vehicle;
the test includes determining whether a predetermined brake pressure, in the form of a reference functionality value, can be generated by the brake system; and
the control is executed in response to the detection of the reduced functionality; and
the reduced functionality is detected in response to the result of the conducted test being that the brake system cannot generate the predetermined brake pressure.

5. The method of claim 1, wherein:
the one or more motor vehicle components includes a communications bus of the motor vehicle;
the test includes determining whether:
a main control unit of the motor vehicle can communicate with the utilized motor vehicle components via the communication bus;
the utilized motor vehicle components can communicate with each other via the communications bus; or
the main control unit of the motor vehicle can communicate with the utilized motor vehicle components via the communication bus and the utilized motor vehicle components can communicate with each other via the communications bus;
the control is executed in response to the detection of the fault; and
the fault is detected based on a negative result of the determination of the test.

6. The method of claim 1, wherein the detection occurs prior to an anticipated traveling of the vehicle on the ramp, and the one or more actions includes controlling the driverless guidance of the vehicle in manner by which the vehicle does not execute the anticipated traveling on the ramp.

7. The method of claim 1, wherein the one or more actions are each selected from the following group of actions:
braking the motor vehicle;
stopping the motor vehicle;
driverlessly guiding the motor vehicle such that the motor vehicle collides with an infrastructure element of the parking lot;
adjusting a steering of the motor vehicle such that the motor vehicle is brought onto a collision course with an infrastructure element of the parking lot;
sending a message, over a wireless communications network to one or more users of the parking lot, a parking lot administrative system of the parking lot, or both the one or more users and the administrative system, that a problem exists; and
outputting one or more warning signals.

8. A device comprising a tester and processing circuitry, wherein the device is configured to execute a method, the method comprising:
prior to and during a driverlessly guided trip of a motor vehicle on an inclined ramp of a parking lot, the tester conducting a test to determine whether one or more motor vehicle components used for the driverless guidance are functioning properly; and
in response to detection, as a result of the conducted test, of a fault in, or a diminished functionality, relative to a reference functionality value, of one of the motor vehicle components, the processing circuitry executing a control of one or more actions to reduce a risk of a possible collision of the motor vehicle with an object due to the faulty or functionally diminished motor vehicle component.

9. A motor vehicle comprising a device that includes a tester and processing circuitry, wherein the device is configured to execute a method, the method comprising:
prior to and during a driverlessly guided trip of a motor vehicle on an inclined ramp of a parking lot, the tester conducting a test to determine whether one or more motor vehicle components used for the driverless guidance are functioning properly; and
in response to detection, as a result of the conducted test, of a fault in, or a diminished functionality, relative to a reference functionality value, of one of the motor vehicle components, the processing circuitry executing a control of one or more actions to reduce a risk of a possible collision of the motor vehicle with an object due to the faulty or functionally diminished motor vehicle component.

10. A non-transitory computer-readable medium on which are stored instructions that are executable by a processor and that, when executed by the processor, cause the processor to perform a method, the method comprising:
prior to and during a driverlessly guided trip of a motor vehicle on an inclined ramp of a parking lot, conduct a test to determine whether one or more motor vehicle components used for the driverless guidance are functioning properly; and
in response to detection, as a result of the conducted test, of a fault in, or a diminished functionality, relative to a reference functionality value, of one of the motor vehicle components, execute a control of one or more actions to reduce a risk of a possible collision of the motor vehicle with an object due to the faulty or functionally diminished motor vehicle component.
